(19) United States
(12) Patent Application Publication
(10) Pub. No.: US 2006/0272611 A1
(43) Pub. Date: Dec. 7, 2006

(54) SYSTEM AND PROCESS FOR CONTROLLING THE FUEL INJECTION OF A DIESEL ENGINE OF A MOTOR VEHICLE

(75) Inventors: Vincent SOUCHON, Paris (FR); Guillaume MEISSONNIER, Landes Le Gaulois (FR); Ludovic PERON, Lailly En Val (FR)

Correspondence Address: NICOLAS E. SECKEL;Patent Attorney, 1250 Connecticut Avenue, NW Suite 700, WASHINGTON, DC, 20036, US

(73) Assignees: PEUGEOT CITROEN AUTOMOBILES SA, Velizy-Villacoublay (FR); DELPHI TECHNOLOGIES, INC., Troy, MI (US)

(21) Appl. No.: 11/422,595

(22) Filed: Jun. 6, 2006

(30) Foreign Application Priority Data
Jun. 7, 2005 (FR) 0505783

(51) Int. Cl. F02D 41/40

(52) U.S. Cl. 123/299

(57) ABSTRACT

A system for controlling the operation of a diesel engine of a motor vehicle equipped with means for supplying fuel to the cylinders thereof in accordance with at least one main injection and a delayed injection of fuel as a function of a predetermined desired value for the crank angle interval separating the delayed injection from the main injection, wherein it comprises means for estimating the crank angle interval separating the delayed injection from the main injection in at least one cylinder and means for controlling the supply means capable of slaving this estimated interval to the desired interval value.

### BACKGROUND OF THE INVENTION

The present invention relates to a system and a process for controlling the operation of a diesel engine of a motor vehicle.

More especially, the present invention relates to such a process and such a system for an engine equipped with means for supplying fuel to the cylinders thereof in accordance with at least one main injection and a delayed injection of fuel as a function of a predetermined desired value for the crank angle interval separating the delayed injection from the main injection.

Typically, the supply of fuel to a cylinder of a diesel engine of a motor vehicle, and more especially the supply to a diesel engine equipped with a common supply rail is divided into at least one main injection of fuel substantially at the top dead centre of the cylinder cycle and one or more delayed injections of fuel during the expansion phase of the cycle.

The use of one or more of these delayed injections has the effect of minimizing the amount of pollutants emitted by the engine while at the same time preserving a satisfactory level of combustion noise.

Typically, a variation in the characteristics of a post-injection, and very especially the crank angle interval separating it from the main injection, brings about a substantial variation in the amount of pollutants emitted.

However, the prior art systems for controlling the supply of fuel to the cylinders actuate the delayed injection in open loop as a function of a predetermined desired value for the crank angle interval. In fact, those systems do not ensure that the real interval separating those two injections is equal to the desired interval value and are generally very sensitive to any type of disturbance, such as the aging of the cylinder injector, for example.

Thus, the emission of pollutants may become rapidly degraded and a resetting of the injection of fuel into the cylinder, or even a replacement of worn parts, is then regularly necessary in order to ensure an optimum level of pollutant emission.

### SUMMARY OF THE INVENTION

The object of the present invention is to solve the above-mentioned problems by proposing a system for controlling the operation of a diesel engine of a motor vehicle which is less sensitive to disturbances in respect of the characteristics of the injection of fuel into the engine cylinders.

To that end, the present invention relates to a system for controlling the operation of a diesel engine of a motor vehicle equipped with means for supplying fuel to the cylinders thereof in accordance with at least one main injection and a delayed injection of fuel as a function of a predetermined desired value for the crank angle interval separating the delayed injection from the main injection, wherein it comprises means for estimating the crank angle interval separating the delayed injection from the main injection in at least one cylinder and means for controlling the supply means capable of slaving this estimated interval to the desired interval value.

According to particular embodiments, the system comprises one or more of the following features:
means for acquiring the cylinder pressure and the crank angle of the at least one cylinder, and the means for estimating the crank angle interval separating the delayed injection from the main injection comprise means for determining the release of heat caused by the combustion of the mixture in the at least one cylinder as a function of the pressure and the crank angle acquired and means for estimating the crank angle interval separating the delayed injection from the main injection as a function of the heat release determined;
the means for estimating the crank angle interval as a function of the release of heat are capable of determining the crank angle (α_peak) of the maximum (h_max) of the heat release determined and a crank angle (α_split) of the start of combustion of a mixture resulting from the delayed injection and of calculating the crank angle interval separating the delayed injection from the main injection as a function of the difference between the crank angle (α_split) of the start of combustion of the mixture resulting from the delayed injection and the angle (α_peak) of the maximum (h_max) of the heat release, which have been determined;
the means for estimating the crank angle interval as a function of the release of heat are capable of determining a crank angle (α_soc) of the start of combustion of a mixture resulting from the main injection into the at least one cylinder and a crank angle (α_split) of the start of combustion of a mixture resulting from the delayed injection and of calculating the crank angle interval separating the delayed injection from the main injection as a function of the difference between the crank angle (α_split) of the start of combustion of the mixture resulting from the delayed injection and the crank angle (α_soc) of the start of combustion of the mixture resulting from the main injection;
   the means for estimating the crank angle interval as a function of the release of heat are capable of determining minima and maxima in a crank angle interval comprising substantially only the delayed injection, and of detecting the crank angle (α_split) of the start of combustion of the mixture resulting from the delayed injection as being the angle of the detected minimum associated with the greatest release of heat between that minimum and the closest subsequent detected maximum;
   the means for controlling the supply means comprise means for regulating the estimated interval in accordance with the desired interval value; and
   the regulation means comprise self-adaptive mapping means or means for cycle-by-cycle regulation or a combination thereof.
The present invention relates also to a process for controlling the operation of a diesel engine of a motor vehicle comprising means for supplying fuel to the cylinders thereof in accordance with at least one main injection and a delayed injection of fuel as a function of a predetermined desired value for the crank angle interval separating the delayed injection from the main injection, wherein it comprises a step of estimating the crank angle interval separating the delayed injection from the main injection in at least one cylinder and a step of controlling the supply means in order to slave that estimated interval to the desired interval value.

The invention will be better understood on reading the following description which is given purely by way of example and in relation to the appended drawings.

### BRIEF DESCRIPTION OF THE DRAWINGS

FIG. 1 is a schematic view of a system according to the invention associated with a propulsion unit having a common supply rail;

FIG. 2 is a graph illustrating the release of heat in a cylinder supplied in accordance with a pilot injection, a main injection and a delayed injection of fuel; and

FIG. 3 is a flow chart of the operation of the system of FIG. 1 illustrating the process according to the invention.

### DESCRIPTION OF PREFERRED EMBODIMENTS

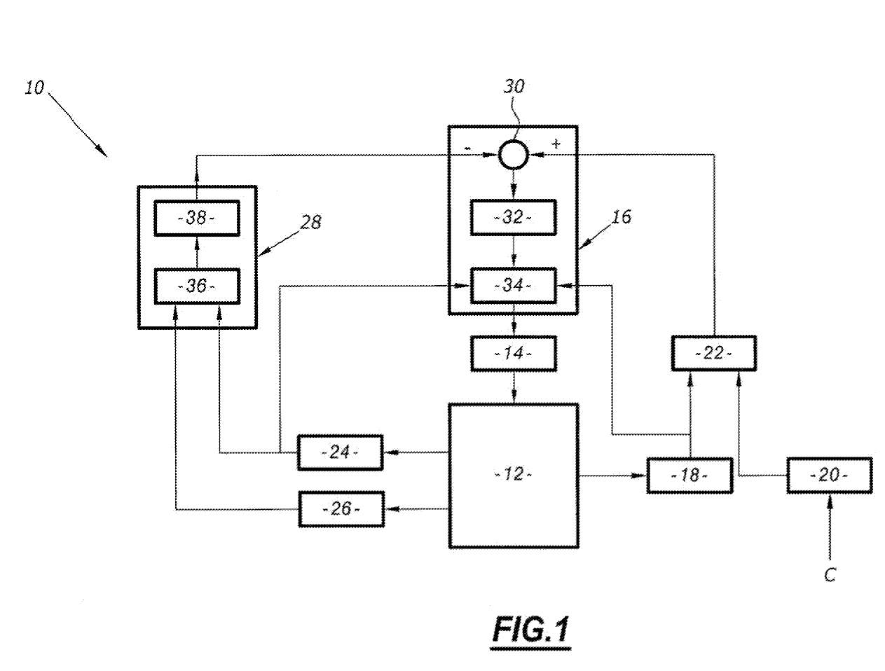

A system 10 for controlling the operation of a diesel engine 12 of a motor vehicle is illustrated schematically in FIG. 1.

The engine 12 is equipped with common rail means 14 for the supply of fuel to the cylinders thereof. The supply means 14 are controlled by means 16 for controlling their operation and processing data.

More especially, the means 16 are capable of controlling the means 14 so that the latter supply each cylinder of the engine 12 in accordance with a pilot injection, a main injection and at least one delayed injection during the expansion phase of the cylinder cycle.

The engine 12 is associated with an acquisition chain 18 for its rotation speed and an acquisition chain 20 for the drive torque desired by the driver of the vehicle, these acquisition chains being known per se in the prior art.

The chains 18, 20 are connected to mapping means 22 comprising a predetermined map of desired values for the injection of fuel into each cylinder as a function of pairs of values of rotation speed and drive torque. These mapping means 22 are capable of evaluating, for the speed and the torque acquired by the chains 18 and 20, their map of desired values and of delivering to the control means 16 a corresponding desired value for the injection of fuel into the cylinders, as known per se in the prior art.

More especially, the mapping means 22 are suitable for delivering, as a function of the speed and the torque acquired, a desired value for the crank angle interval separating the delayed injection from the main injection.

The engine 12 is also associated with acquisition chains 24, 26 for the crank angle and the pressure in the combustion chamber, or cylinder pressure, of each cylinder of the engine.

The system 10 according to the invention comprises, connected to the acquisition chains 24, 26 for the crank angle and the cylinder pressure of the cylinder and to the control means 16, means 28 for estimating the crank angle interval separating the delayed injection from the main injection of fuel into the cylinder, as will be explained in more detail hereinafter.

The control means 16 are capable of implementing a slaving of the angle interval estimated by the means 28 to the desired angle interval value delivered by the mapping means 22.

More especially, the control means 16 are capable of implementing a regulation of the estimated interval in accordance with the desired interval value so that the real crank angle interval between the delayed injection and the main injection is substantially equal to the desired interval value.

For that purpose, the control means 16 comprise:
a subtractor 30 connected to the means 22 and 28 and forming the difference between the desired interval value and the estimated interval, or regulation error;
regulation means 32 connected to the subtractor 30 and capable of implementing a predetermined law for the regulation of the estimated interval in accordance with the desired interval value and thus of delivering as an output a signal for regulation as a function of the regulation error; and
actuating means 34 connected to the regulation means 32, to the acquisition chains 24, 18 for the rotation speed of the engine and the crank angle of the cylinder and to the supply means 14. The actuating means 34 are capable of actuating the supply means 14 as a function of the signals they receive for triggering the pulses for actuating a cylinder injector, as is known in the prior art.

The regulation means 32 comprise, for example, a self-adaptive map and/or a cycle-by-cycle regulator or a combination thereof. The slow loop may, for example, comprise a so-called “self-adaptive” map which enables the interval errors to be stored and up-dated as a function of their location in the engine field defined, for example, by the drive torque and the speed.

The means 28 for estimating the crank angle interval separating the delayed injection and the main injection comprise means 36 for calculating the instantaneous release of heat caused by the combustion of the mixture of fuel and fresh gas, or mixture, in the cylinder during the combustion phase of the cycle thereof.

This calculation is carried out by the calculation means 36 on the basis of the first principle of thermodynamics and more especially in accordance with the relationship:

$$\frac{ⅆ Q}{ⅆ α} = \frac{1}{k - 1} \times ( V \times \frac{ⅆ P}{ⅆ α} - k \times P \times \frac{ⅆ V}{ⅆ α} ) \qquad ( 1 )$$

where dα is a predetermined variation in the crank angle α of the cylinder, dQ is the amount of instantaneous heat released by the combustion of the mixture during the variation dα of the crank angle, V and P are the volume of the combustion chamber and the pressure therein at the time of the start of the variation dα of the crank angle, respectively, the volume V being, for example, tabulated in the means 36 as a function of the crank angle, dV and dP are the variations in the volume of the combustion chamber and in the pressure therein corresponding to the variation dα of the crank angle, respectively, and k is a predetermined polytropic coefficient.

The means 36 for calculating the release of heat are connected to estimation means 38 suitable for estimating the crank angle interval separating the delayed injection from the main injection as a function of the calculated release of heat, in a manner which will be explained in more detail hereinafter.

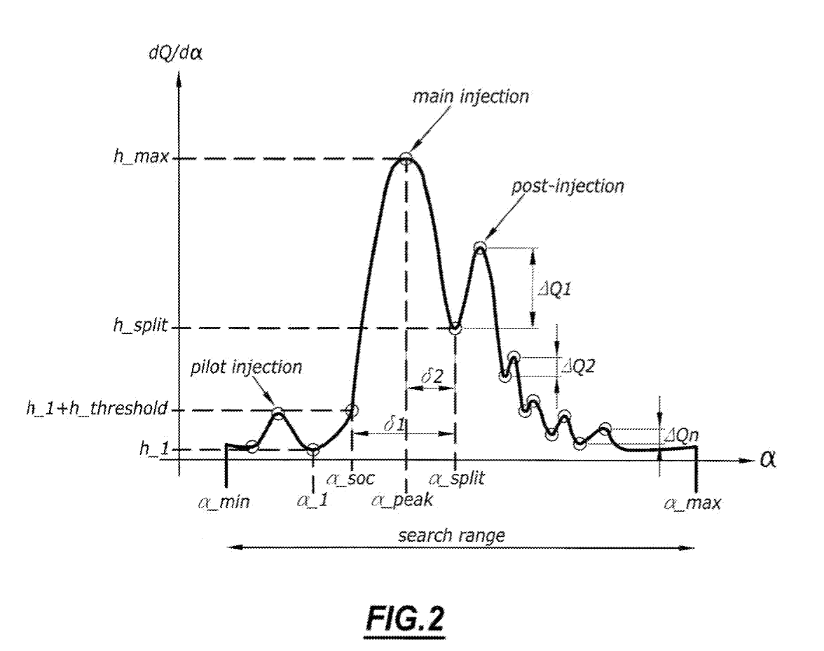

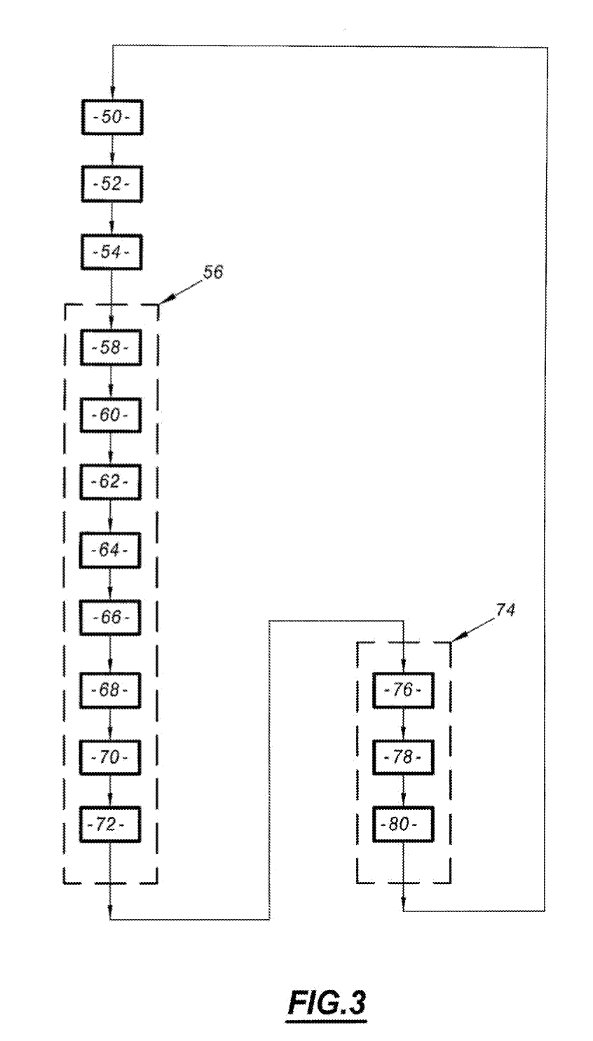

The operation of the system according to the invention and more especially the operation of the estimation means 38 will now be described with reference to FIGS. 2 and 3.

FIG. 2 is a graph of a curve of the heat release calculated by the calculation means 36 as a function of the crank angle of the cylinder for a predetermined range of cylinder crank angles [α_min,α_max] in which the pilot and main injections and also the delayed injection take place. This range is, for example, equal to [−20, 90] crank degrees, the zero corresponding to the top dead centre of the cylinder cycle, and this range will be referred to in the description hereinafter by the terms “search” range.

Referring to the flow chart of FIG. 3, in a step 50, the rotation speed of the engine 12 and the torque desired by the driver are acquired by the acquisition chains 18, 20 and a desired interval value is determined by the mapping means 22 as a function thereof.

In a following step 52, the cylinder pressure and the crank angle of the cylinder are acquired by the acquisition chains 24, 36 for the current engine cycle, then, at 54, the release of heat for the search range is calculated by the calculation means 36 as a function of the pressure and the crank angle acquired.

A step 56 for estimating the angle interval separating the delayed injection from the main injection is then triggered.

This step 56, implemented by the estimation means 38, comprises a step 58 for determining the maximum h_max of the release of heat over the search range [α_min, α_max] and its corresponding crank angle α_peak. This global maximum over the range [α_min, α_max] corresponds to the maximum heat released during the combustion of the mixture resulting from the main injection.

Subsequently, in a step 60, all of the local minima, and their corresponding angular positions, are determined over the range of angles [α_min, α_peak]. For example, these minima and their crank angles are calculated by determining the angular positions for which the derivative of the heat release calculated by the means 36 is cancelled and changes sign on passing from a negative value to a positive value.

The minimum among the minima determined, the angular position α_{—}1 of which is closest to the angular position α_peak of the maximum h_max, is selected at 62 and the value h_{—}1 of the release of heat for the angle α_{—}1 is memorized.

A crank angle α_soc of the start of the combustion of the mixture resulting from the main injection is then determined at 64 by selecting the crank angle of the range [α_{—}1,α_peak] for which the value of the release of heat is substantially equal to the sum h_{—}1 +h_threshold of the value h_{—}1 of the release of heat for the angle α_{—}1 and a predetermined threshold value h_threshold. The threshold value h_threshold is preferably from 0 to 5 J/deg.

The operation of the system according to the invention then continues with the determination of the angle of the start of combustion of the delayed injection in a range of crank angles comprising substantially only the delayed injection, for example the range [α_peak, α_max].

First of all, a step 66 of the step 56 for estimating the interval separating the delayed injection from the main injection consists in determining all of the maxima and minima of the release of heat in the range of crank angles [α_peak, α_max].

Then, in a step 68, for each minimum determined at 66, a divergence ΔQ1, ΔQ2, . . . , ΔQn between the release of heat for this minimum and the release of heat for the subsequent maximum and the closest to the latter is calculated.

The maximum among the divergences ΔQ1, ΔQ2, . . . , ΔQn thus calculated is selected at 70. The angular position α_split of the minimum of the selected divergence corresponds to the crank angle of the start of the combustion in the cylinder of the mixture resulting from the delayed injection.

The crank angle interval separating the delayed injection from the main injection is then calculated at 72.

In a first embodiment, the interval separating these injections is defined as being the crank angle interval δ1 separating the angle α_split of the start of the combustion of the mixture resulting from the delayed injection from the angle α_soc of the start of the combustion of the mixture resulting from the main injection. This interval δ1 is then estimated in accordance with the relationship δ1=α_split−α_soc.

In a second embodiment, the interval separating these injections is defined as being the crank angle interval δ2 separating the angle α_split of the start of the combustion of the mixture resulting from the delayed injection from the angle α_peak of the maximum of the combustion of the mixture resulting from the main injection. This interval δ2 is then estimated in accordance with the relationship δ2=α_split−α_peak.

A following step 74 of the operation of the system of FIG. 1 is a step of regulating the estimated interval in accordance with the desired interval value and is implemented by the means 16 for controlling the supply means.

This step 74 comprises a step 76 of the formation by the subtractor 60 of the difference between the desired interval value determined at 50 and the interval estimated at 56.

A regulating signal is then calculated at 78 by the regulation means 32 as a function of this difference and is then delivered to the means 34 for actuating the supply means 14.

The means 34 then actuate at 80 the supply means 14 as a function of the calculated regulating signal, then step 80 loops onto step 50 for a fresh calculation cycle.

Thus, the crank angle interval separating the delayed injection from the main injection in the cylinder is regulated in accordance with the desired interval value delivered by the means 22 mapping desired injection values.

What is claimed is:

1. A system for controlling the operation of a diesel engine of a motor vehicle equipped with means for supplying fuel to the cylinders thereof in accordance with at least one main injection and a delayed injection of fuel as a function of a predetermined desired value for the crank angle interval separating the delayed injection from the main injection, wherein it comprises means for estimating the crank angle interval separating the delayed injection from the main injection in at least one cylinder and means for controlling the supply means capable of slaving this estimated interval to the desired interval value.

2. A system according to claim 1, wherein it comprises means for acquiring the cylinder pressure and the crank angle of the at least one cylinder, and in that the means for estimating the crank angle interval separating the delayed injection from the main injection comprise means for determining the release of heat caused by the combustion of the mixture in the at least one cylinder as a function of the pressure and the crank angle acquired and means (38) for estimating the crank angle interval separating the delayed injection from the main injection as a function of the heat release determined.

3. A system according to claim 2, wherein the means for estimating the crank angle interval as a function of the release of heat are capable of determining the crank angle of the maximum of the heat release determined and a crank angle of the start of combustion of a mixture resulting from the delayed injection and of calculating the crank angle interval separating the delayed injection from the main injection as a function of the difference between the crank angle of the start of combustion of the mixture resulting from the delayed injection and the angle of the maximum of the heat release, which have been determined.

4. A system according to claim 2, wherein the means for estimating the crank angle interval as a function of the release of heat are capable of determining a crank angle of the start of combustion of a mixture resulting from the main injection into the at least one cylinder and a crank angle of the start of combustion of a mixture resulting from the delayed injection and of calculating the crank angle interval separating the delayed injection from the main injection as a function of the difference between the crank angle of the start of combustion of the mixture resulting from the delayed injection and the crank angle of the start of combustion of the mixture resulting from the main injection.

5. A system according to claim 3, wherein the means for estimating the crank angle interval as a function of the release of heat are capable of determining minima and maxima in a crank angle interval comprising substantially only the delayed injection, and of detecting the crank angle of the start of combustion of the mixture resulting from the delayed injection as being the angle of the detected minimum associated with the greatest release of heat between that minimum and the closest subsequent detected maximum.

6. A system according to claim 1, wherein the means for controlling the supply means comprise means for regulating the estimated interval in accordance with the desired interval value.

7. A system according to claim 6, wherein the regulation means comprise self-adaptive mapping means or means for cycle-by-cycle regulation or a combination thereof.

8. A process for controlling the operation of a diesel engine (12) of a motor vehicle comprising means for supplying fuel to the cylinders thereof in accordance with at least one main injection and a delayed injection of fuel as a function of a predetermined desired value for the crank angle interval separating the delayed injection from the main injection, wherein it comprises a step of estimating the crank angle interval separating the delayed injection from the main injection in at least one cylinder and a step of controlling the supply means in order to slave that estimated interval to the desired interval value.
